(19) United States
(12) Patent Application Publication
(10) Pub. No.: US 2021/0152121 A1
(43) Pub. Date: May 20, 2021

(54) SOLAR PANEL POWER SYSTEM ABNORMALITY DIAGNOSIS AND ANALYSIS DEVICE AND METHOD BASED ON FHMM AND PREDICTION OF POWER GENERATION

(71) Applicant: INSTITUTE FOR INFORMATION INDUSTRY, Taipei (TW)

(72) Inventors: Fang-Yi CHANG, Taipei (TW); Yung-Chieh HUNG, Taipei (TW)

(73) Assignee: INSTITUTE FOR INFORMATION INDUSTRY, Taipei (TW)

(21) Appl. No.: 16/699,282

(22) Filed: Nov. 29, 2019

(30) Foreign Application Priority Data
Nov. 14, 2019 (TW) 108141400

(51) Int. Cl. H02S 50/10; G06Q 50/06; G06F 17/18; G01W 1/00

(52) U.S. Cl. CPC H02S 50/10; G01W 1/00; G06F 17/18; G06Q 50/06

(57) ABSTRACT

A power generation system abnormality diagnosis and analysis device for diagnosing a solar power generation system in which plural modules are connected in parallel. The analysis device includes a total current detection module for providing a total current sequence data and an observed voltage value; an environmental information module for providing an environmental information; a FHMM calculation module for performing a FHMM calculation on the sequence data to obtain plural sets of first current inference values and extracting a set of second current inference values from the sets of first current inference values according to the environmental information and a current voltage history database; a database building module for recording an observed voltage value and the set of second current inference values; and a user feedback module for determining whether to issue an abnormality warning according to the set of second current inference values and the observed voltage value.

This application claims the benefit of Taiwan application Serial No. 108141400, filed Nov. 14, 2019, the subject matter of which is incorporated herein by reference.

### BACKGROUND OF THE INVENTION

### Field of the Invention

The invention relates in general to a method for monitoring a solar panel power generation system in which plural solar power generation modules are connected in parallel. The method can predict the power generation state of each solar power generation module by using only one voltage/current meter to measure the total output of the current and the magnitude of the voltage of plural solar power generation modules connected in parallel.

### Description of the Related Art

Referring to FIG. 1A, a schematic diagram of a conventional solar panel power generation system is shown. The solar panel power generation system includes four solar power generation module series connected in parallel, wherein each module series further has plural solar power battery modules connected in parallel or series to generate power in the module. Each solar power generation module series outputs a current of 12V-5A, and the four module series are connected in parallel for outputting a current of 12V-20A. The charging manager 12 charges the battery 10 with the outputted current of 12V-20A.

Thus, when one of the solar power battery modules breaks down or ages and causes the total power output of the power generation system connected in parallel to decline, the maintenance staff need to check the four solar power generation module series one by one to find out which one is faulty. Such maintenance work is very tedious and time consuming.

On the other hand, if four electric meters are respectively installed on the four solar power generation module series in advance to measure the output current of each of the four power generation module series directly, the faulty power generation module series can be quickly identified. However, such arrangement is very expensive.

### SUMMARY OF THE INVENTION

The invention relates to a solar panel power system abnormality diagnosis and analysis technology based on the factorial hidden Markov model (FHMM) and the prediction of power generation. Electric data are outputted through a DC combiner box, unsupervised learning is performed using a FHMM model, and hourly operation state of each module series is analyzed. Based on the above results and aided by weather information, such as sunshine intensity and temperature, whether the volume of power generation of each module series is a reasonable output is analyzed, and the result of analysis is fed back to the maintenance operator of the solar power plant.

According to an aspect of the present invention, a power generation system abnormality diagnosis and analysis device is provided. The power generation system abnormality diagnosis and analysis device is for diagnosing and analyzing a solar panel power generation system in which plural solar power generation module series are connected in parallel for outputting a total current. The abnormality diagnosis and analysis device includes a total current detection module for detecting a total current and outputting a time sequence data and an observed voltage value; an environmental information module for providing an environmental information regarding the location of the solar panel power generation system; a FHMM calculation module for performing a FHMM calculation on the time sequence data to obtain plural sets of first current inference values and extracting a set of second current inference values from the plural sets of first current inference values according to the environmental information and a current voltage history database; a database building module for recording the observed voltage value and the set of second current inference values to update the current voltage history database; and a user feedback module for comparing the set of second current inference values and the observed voltage value with the current voltage history database to determine whether to issue an abnormality warning.

According to an embodiment of the present invention, the environmental information at least includes a sunshine intensity status, and when the set of second current inference values is extracted from the plural sets of first current inference values, the current voltage value under similar sunshine intensity status among the current voltage history database is compared.

According to an embodiment of the present invention, the environmental information at least includes a temperature status, and when the set of second current inference values is extracted from the plural sets of first current inference values, the current voltage value under similar temperature status among the current voltage history database is compared.

According to an embodiment of the present invention, when a set of second current inference values is extracted from the plural sets of first current inference values, at least two similarity extraction algorithms are used, and the results of the at least two similarity extraction algorithms are accumulated and used as similarity measures. The similarity extraction algorithms include at least two of the K-nearest neighbors algorithm, the inner product similarity matrix algorithm, the Gaussian kernel algorithm and the Euclidean distance algorithm.

According to an embodiment of the present invention, the current voltage history database shows that the X-th of the module series has a first daily low power generation period T(X), and the Y-th of the module series has a second daily low power generation period T(Y); the FHMM calculation module performs at least one FHMM calculation during the first daily low power generation period T(X) and the second daily low power generation period T(Y) respectively, the FHMM calculation module uses the lowest among the second current inference values during the first daily low power generation period T(X) as the inference current value of the X-th module series and uses the lowest among the second current inference values during the second daily low power generation period T(Y) as the inference current value of the Y-th module series; the first daily low power generation period T(X) is different from the second daily low power generation period T(Y).

According to an embodiment of the present invention, the environmental information module detects an environmental information, including a sunshine intensity status and a temperature status, when the FHMM calculation is performed during the first daily low power generation period T(X); the inference current value of the X-th module series and the observed voltage value are compared with the current voltage value under similar sunshine intensity status and temperature status among the current voltage history database when the FHMM calculation is performed to determine whether to issue an abnormality warning of the X-th module series.

According to another aspect of the present invention, a power generation system abnormality diagnosis and analysis method is provided. The diagnosis and analysis method is for diagnosing analysis a solar panel power generation system in which plural solar power generation module series are connected in parallel for outputting a total current. The abnormality diagnosis and analysis method includes the steps of: detecting the total current and outputting a time sequence data and an observed voltage value; performing a FHMM calculation on the time sequence data to obtain plural sets of first current inference values, and extracting a set of second current inference values from the plural sets of first current inference values according to an environmental information and a current voltage history database; recording the observed voltage value and the second current inference values to update the current voltage history database; and comparing the second current inference values and the observed voltage value with the current voltage history database to determine whether to issue an abnormality warning.

The above and other aspects of the invention will become better understood with regards to the following detailed description of the preferred but non-limiting embodiment (s). The following description is made with reference to the accompanying drawings.

### BRIEF DESCRIPTION OF THE DRAWINGS

FIG. 1A (prior art) is a schematic diagram of a conventional solar panel power generation system in which four solar power generation modules are connected in parallel according to the invention.

FIG. 1B is a schematic diagram of an abnormality diagnosis and analysis device used in a conventional power generation system in which four solar power generation module series are connected in parallel according to the invention.

FIG. 2 is a schematic diagram of a solar panel power system abnormality diagnosis and analysis device according to the invention.

FIG. 3 is a flowchart of a power generation system abnormality diagnosis and analysis method according to the invention.

FIG. 4 is a total current chart of four solar power generation modules series connected in parallel according to the invention.

FIG. 5 is a diagram showing the factorial relationship among four series of a constrained FHMM model at time point t.

### DETAILED DESCRIPTION OF THE INVENTION

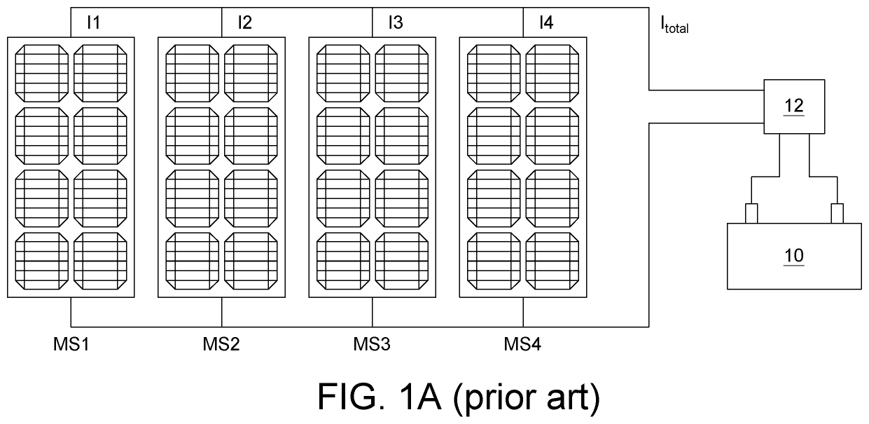

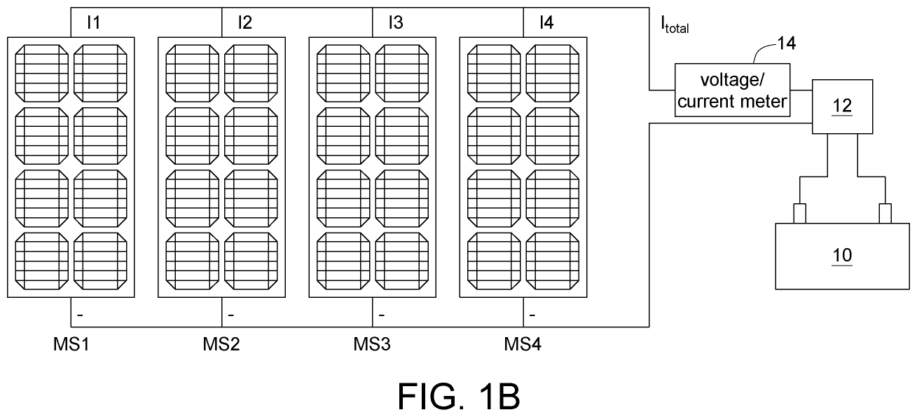

FIG. 1B is a schematic diagram of an abnormality diagnosis and analysis device used in a conventional power generation system in which four solar power generation module series are connected in parallel according to the invention. The solar panel power generation system includes four solar power generation module series MS1˜MS4 connected in parallel, for outputting currents I1˜I4 respectively. The four solar power generation module series MS1˜MS4 are connected in parallel for outputting a total current I-total. A voltage/current meter 14 is disposed on the path of the total current I-total for measuring the total current/voltage value.

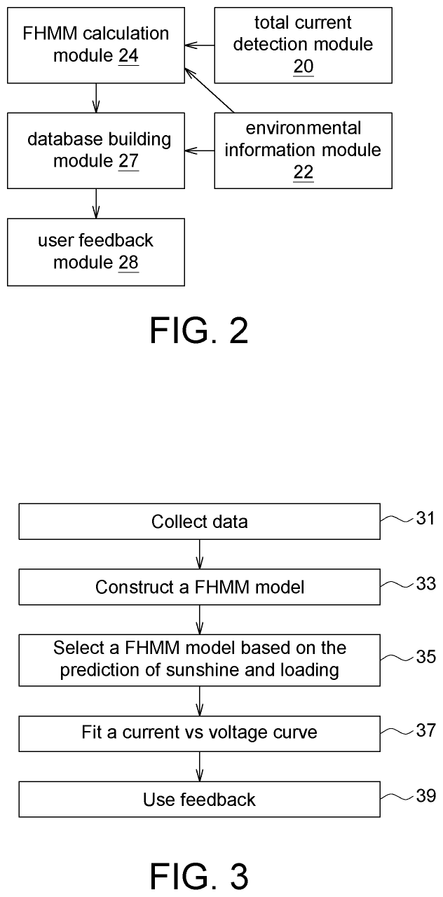

FIG. 2 is a schematic diagram of a solar panel power system abnormality diagnosis and analysis device according to the invention. The abnormality diagnosis and analysis device includes a total current detection module 20, an environmental information module 22, a FHMM calculation module 24, a database building module 27 and a user feedback module 28. The main functions of each module are as follow. The total current detection module 20 includes a voltage/current meter 14 for detecting a total current !-total and outputting a time sequence data and an observed voltage value. The environmental information module 22 is for providing an environmental information regarding the location of the solar panel power generation system. The FHMM calculation module 24 is for performing a FHMM calculation on the time sequence data to obtain plural sets of first current inference values, and extracting a set of second current inference values from the plural sets of first current inference values according to the environmental information, provided by the environmental information module 22, and a current voltage history database. The database building module 27 is for recording the observed voltage value and the set of second current inference values to update the current voltage history database. The user feedback module 28 is for comparing the set of second current inference values and the observed voltage value with the current voltage history database to determine whether to issue an abnormality warning.

FIG. 3 is a flowchart a power generation system abnormality diagnosis and analysis method according to the invention. The analysis method includes the following steps: (31) data collection, (33) construction of a FHMM model, (35) selection of a FHMM model based on the prediction of sunshine and loading, (37) fitting current vs voltage curve, and (39) user feedback. Detailed steps of the analysis method are disclosed below.

In step (31), data is collected. Low frequency data sampling is performed on the current loading curve obtained by the voltage/current meter 14 as indicated in FIG. 1B. After the above data is obtained, the obtained data is stored to a database and is processed with a pre-treatment, including data integration, data cleansing, and maximum-minimum standardization. Suppose the value of the total current I-total is measured and recorded per minute. After four hours, a sequence {Y-total-n} of 240 observed values of the total current, that is, Y-total-1˜Y-total-240, will be obtained, wherein, n=1:240. Likewise, for each of the four power generation module series MS1˜MS4, a corresponding sequence {Yn, k} can be generated by using the analysis method of the invention, wherein n=1:240 represents 240 observations, and k=1:4 respectively corresponds to the four solar power generation module series MS1˜MS4.

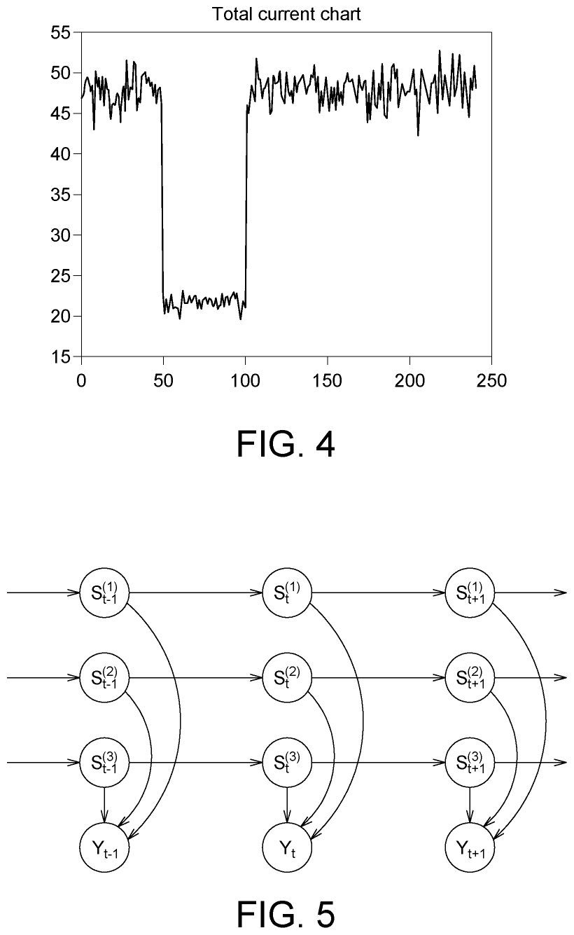

In other words, {Y-total-n}, n=1:N, is a time sequence of total current, wherein Y-total-n represents the total current value measured at time point n by way of low frequency sampling. {Yn,1}, n=1:N represents a time sequence of the current flowing through the first module series MS1. For example, Yn,1 represents the value of the current flowing through the first module series MS1 at time point n. {Yn,2}, n=1:N represents a time sequence of the current flowing through the second module series MS2. For example, Yn,2 represents the value of the current flowing through the second module series MS2 at time point n. The designations of the values of the currents flowing through the remaining module series can be obtained by the same analogy. The variable N represents the number of observation time points. In the embodiments of the invention, the total current chart of FIG. 4 is measured by way of low frequency sampling (the total current I-total is measured once per minute, and the measurement lasts for four hours), and 240 recording time points are obtained. Therefore, N is 240, and n progressively increases from 1 to 240. The observation time point n satisfies the following equation:

Yn,1+Yn,2+Yn,3+Yn,4=Y-total-n.

In step (33), a FHMM model is constructed. 60 measurements are obtained per hour, wherein 60 observations (that is, the total current) of the current value {Yₜ}_{t=1:60} can be measured by the current meter Meter-I. {Sₜ}_{t=1:60} represents a hidden state value, which cannot be measured by the current meter Meter-I, but can be inferred from the FHMM model. In the FHMM model:

a) Sₜ represents all states, namely, Sₜ⁽¹⁾, Sₜ⁽²⁾, Sₜ⁽³⁾, Sₜ⁽⁴⁾, at time point t, wherein the superscripts 1˜4 respectively represent the state of each of the four series at time point t.

b) Sₜ^{(m)} has two possible values: when Sₜ^{(m)}=1, this implies that the power generation function at time point t is normal; when Sₜ^{(m)}=2, this implies that the power generation function at time point t is abnormal, wherein m (=1, 2, 3, or 4) corresponds to the four series. For example, when m=3, t=20, Sₜ^{(m)}=1, this implies that the power generation function of the third series at time point t=20 is normal.

c) the FHMM model of the invention is constrained. Here, the constraint is: P(Sₜ|Sₜ₋₁)=πₘ₌₁²P(Sₜ^{(m)}|Sₜ₋₁^{(m)}) (because there are two states only, namely, normal (Sₜ^{(m)}=1) and abnormal (Sₜ^{(m)})=2). Conventional HMM models are not multiplied together, but are multiplied together in the FHMM. If the FHMM is not constrained, the FHMM is merely a combination of four parallel HMM models without factorial relationship. As indicated in FIG. 5, Sₜ₋₁⁽²⁾ affects Sₜ⁽²⁾, Sₜ⁽²⁾ affects Sₜ₊₁⁽²⁾, and Sₜ⁽¹⁾, Sₜ⁽²⁾, Sₜ⁽³⁾ together affect Yₜ.

The transfer matrix of the FHMM model of the invention represents the probability of a series changed to the next state from the current state. As disclosed above, suppose each series has two states, being normal state and abnormal state. When the power generation function of the m-th series at time point t is normal, Sₜ^{(m)}=1; when the power generation function of the m-th series at time point t is abnormal, Sₜ^{(m)}=2. The transfer matrix P^{(m)} representing the probabilities of the four scenarios of transfer, namely, “normal→normal”, “normal→abnormal”, “abnormal→normal”, and “abnormal→abnormal” can be expressed as:

$$( \begin{matrix}1 - λ & λ \\ λ & 1 - λ\end{matrix} )$$

Since the observed value provided by the current meter is the total current state value Yt of power generation, St is a value that needs to be estimated for evaluating whether the state of each series is normal or abnormal. That is, the value of each St is estimated by the FHMM model according to the total current state value Yt of power generation. That is, which value of St will maximize the probability of obtaining the observed value of Yt needs to be located. Thus, the probability of obtaining the total current state value Yt of power generation in correspondence to the combination of the states St1˜St4 is calculated one by one. Then, the combination of the states St1˜St4 maximizing the probability of obtaining Yt is used and inferred as the current power generation state of the four series.

Generally speaking, the relationship between the total current and the hidden layer parameters St1˜St4 satisfies the following expression:

Y_{n,m}(Y-totalₙ)=P(Y-totalₙ|S^{(m)=}i)

Moreover, P(Y-totalₙ|S^{(m)=}i) is normally constructed as a Gaussian distribution N(Y-totalₙ; μm, σₘ), wherein μₘ and σₘ respectively are the mean and the standard error of the total current with respect to the state S^{(m)=}i.

$$P ( {Y}_{t} \vert {S}_{t}^{( m )} = i ) = \vert {C}^{- \frac{1}{2}} \vert {( 2 π )}^{- \frac{1}{2}} exp \{ \frac{- 1}{2} {( {Y}_{t} - {μ}_{t \vert {{s}_{t} ( m )}_{= i}} )}^{′} {C}^{- 1} ( {Y}_{t} - {μ}_{t \vert {{s}_{t} ( m )}_{= i}} ) \} \qquad ( a )$$

For an observed current value Yt, the Bayes' theorem is used to locate which among all combinations of St will maximize the probability of obtaining the current value Yt. Based on formula (a), given that the value Yt is already known, the probability of obtaining Sₜ^{(m)} can be expressed as:

$$Bayes ' theorem \text{:} P ( {S}_{t}^{( m )} \vert {Y}_{t} ) = \frac{P ( {Y}_{t} \vert {S}_{t}^{( m )} ) P ( {S}_{t}^{( m )} )}{{\sum }_{i = 1}^{2} P ( {Y}_{t} \vert {S}_{t}^{( m )} = i ) P ( {S}_{t}^{( m )} = i )}$$

Here, the Bayes' theorem already indicates a specific series, therefore i=1˜2, whether the series is normal or not is evaluated according to the above probability, and the probability threshold for evaluation is 0.8. A series is determined as faulty if the probability of faulty calculated according to the Bayes' theorem is over 0.75 or 0.8.

The current value of the k=th of the four series at time point t is estimated according to the following formula:

Y_{t,k}=E(Y_{t,k}|Yₜ)=Σₘ₌₁²μ_{t,m}P(Sₜ^{(k)}=m|Yₜ), K=1˜4, m=1˜2.

Here below, parameters are estimated using the mean field approximation method whose input values include {Y-totalₙ} n=1:N, the number of series, and the number of states S^{(m)}. Relevant parameters are approximated and estimated according to the mean field theory, and the obtained values include {μₘ}m=1:4, P(S^{(m)=}1) m=1:4 or P(S^{(m)=}2) m=1:4 and transfer matrix P^{(m)} m=1:4.

In step (35), a FHMM model based on the prediction of sunshine and loading is selected. The FHMM model estimates relevant parameters using the mean field approximation method. The mean field approximation method requires an initial value for performing calculation of the algorithm. Normally, relevant initial values are randomly generated and used as input values of the mean field approximation method. The common stochastic model is Gaussian distribution, and a stochastic uniform distribution model. However, different initial values will more or less affect the accuracy of parameter estimation despite that the difference is minor. Therefore, the invention provides a method including steps (a) to (c) to increase the accuracy. In step (a), 10 sets of different initial value are randomly generated with respect to the same data set. In step (b), a calculation of structured variational inference is performed for each initial value to obtain 10 sets of different parameters. In step (c), the most similar parameter is located by using an integrated algorithm according to observed sunshine, predicted volume of power generation and historical data of the data set (historical observed sunshine, historical predicted volume of power generation and parameter generated from structured variational inference). The invention uses four algorithms, namely, the K-nearest neighbors (KNN) algorithm, the inner product similarity matrix algorithm, the Gaussian kernel algorithm and the Euclidean distance algorithm, as similarity measures. Each algorithm is counted 1 score, the total score of each θ value is accumulated, and the θ value with the largest score (the θ value most similar to the historical data) is selected as the calculation parameter. For example, 10 θ values are selected, the calculation is started, and 10 sets of first current inference values are obtained. Then, 8 candidate θ values are obtained by deducting two θ values with over-sized errors from the 10 θ values. Then, the θ value with the highest similarity is selected and used as a parameter for initial value, and the set of current inference values correspondingly obtained is extracted and used as a set of second current inference values.

The estimation of parameter using the mean field approximation method is exemplified by FIG. 4. The method includes (a) generating 10 sets of different initial value at random with respect to the same data set; (b) performing a calculation of structured variational inference for each initial value to obtain 10 sets of different parameters.

FIG. 4 is a total current chart of four solar power generation modules series connected in parallel according to the invention. FIG. 4 illustrates 240 recording time points with a covariance C of 70.5597. The results obtained from the first calculation of the mean field approximation algorithm performed on the total current chart as indicated in FIG. 4 are listed below:

TABLE 1
{μₘ}

| Index | μ_{t\|s}_{ₜ}_{^{(m)}}₌₁ | μ_{t\|s}_{ₜ}_{^{(m)}}₌₂ |
|---|---|---|
| m = 1 | 9.4860 | 9.0975 |
| m = 2 | 9.3297 | 9.2538 |
| m = 3 | 9.2538 | 9.3327 |
| m = 4 | 17.9295 | 0.6540 |

TABLE 2
P(S^{(m)=} 1) or P(S^{(m)=} 2)

| Index | S(m) = 1 | S(m) = 2 |
|---|---|---|
| m = 1 | 0.5170 | 0.4830 |
| m = 2 | 0.4059 | 0.5941 |
| m = 3 | 0.6759 | 0.3241 |
| m = 4 | 0.8018 | 0.1982 |

| Index | Transfer Matrix |
|---|---|
| m = 1 | $( \begin{matrix}0.5 & 0.5 \\ 0.5 & 0.5\end{matrix} )$ |
| m = 2 | $( \begin{matrix}0.5 & 0.5 \\ 0.5 & 0.5\end{matrix} )$ |
| m = 3 | $( \begin{matrix}0.5 & 0.5 \\ 0.5 & 0.5\end{matrix} )$ |
| m = 4 | $( \begin{matrix}0.5 & 0.5 \\ 0.5 & 0.5\end{matrix} )$ |

The current inference value of respectively series of the four module series can be calculated according to formula (a) to formula (c) below. In regard to formula (a), the value of μ_{t|s}_{ₜ}_{^{(m)}}₌₁ or μ_{t|s}_{ₜ}(m)₌₂ can be obtained by looking up Table 1; Yₜ represents an observed total current value; C represents the covariance disclosed above, wherein i=1 or 2 represents the normal state (i=1) and the abnormal state (i=2) of the module series; and variable m=1:4 represents the four series and varies between 1 and 4.

$$P ( {Y}_{t} \vert {S}_{t}^{( m )} = i ) = \vert {C}^{- \frac{1}{2}} \vert {( 2 π )}^{- \frac{1}{2}} exp \{ \frac{- 1}{2} {( {Y}_{t} - {μ}_{t \vert {{s}_{t} ( m )}_{= i}} )}^{′} {C}^{- 1} ( {Y}_{t} - {μ}_{t \vert {{s}_{t} ( m )}_{= i}} ) \} \qquad ( a )$$

Formula (b) represents the probability of the m-th series at time point n being in state i given that the observed total current value Yₜ is known. The value of formula (b) can be obtained by substituting the result of formula (a) to formula (b).

$$P ( {S}_{t}^{( m )} = i \vert {Y}_{t} ) = \frac{P ( {Y}_{t} \vert {S}_{t}^{( m )} = i ) P ( {S}_{t}^{( m )} = i )}{{\sum }_{i = 1}^{2} P ( {Y}_{t} \vert {S}_{t}^{( m )} = i ) P ( {S}_{t}^{( m )} = i )} \qquad ( b )$$

Formula (c) represents the first set of first current inference values. The value of formula (c), which includes respective current inference value of each of the four module series, can be obtained by substituting the result of formula (b) to formula (c).

$$( {Y}_{t , m} \vert {Y}_{t} ) {\sum }_{i = 1}^{2} {μ}_{t \vert {s}_{t}^{( m )} = i} P ( {S}_{t}^{( m )} = i \vert {Y}_{t} ) \qquad ( c )$$

Then, the second to the tenth calculation of the mean field approximation algorithm are performed on the total current chart as indicated in FIG. 4. Another 9 sets of first current inference values can be obtained by performing the same algorithm. Thus, 10 sets of first current inference values can be obtained after the FHMM calculations are completed.

The implementation of step (c) is exemplified by FIG. 4. When the set of second current inference values is extracted from the plural sets of first current inference values, the current voltage under similar temperature and sunshine intensity status among the current voltage history database is compared. That is, a set of second current inference values is extracted from the plural sets of first current inference values according to the environmental information, provided by the environmental information module 22, and a current voltage history database.

Based on the sunshine intensity/temperature status when observing the total current, the plural sets of first current inference values are compared with “the current voltage value under similar temperature/sunshine intensity status among the current voltage history database”. The set of current inference value with highest similarity with the historical current voltage under similar temperature status and sunshine intensity status are selected from the plural sets of first current inference values and used as the set of second current inference values. In the invention, at least two similarity extraction algorithms are used, and the results of the at least two similarity extraction algorithms are accumulated and used as similarity measures, the set of current inference value with highest similarity are extracted from the 10 sets of first current inference values and used as a set of second current inference values. The similarity extraction algorithms used as similarity measures in the invention include at least two of the K-nearest neighbors (KNN) algorithm, the inner product similarity matrix algorithm, the Gaussian kernel algorithm and the Euclidean distance algorithm. Each algorithm is counted 1 score, the total score of the 10 sets of first current inference values is accumulated, and the set of first current inference values with highest score is selected as the second current inference value. That is, the set of first current inference values with highest similarity with the historical current voltage under similar temperature the sunshine intensity status among the historical data is selected. In the present embodiment, 10 initial parameter values are selected, the calculation of the mean field approximation algorithm is started, and 8 candidate sets of first current inference values are obtained by deducting two sets with over-sized errors from the 10 sets of first current inference values. Then, the first current inference value with highest similarity is selected as the second current inference value.

In step (37), a current vs voltage curve is fitted. The set of second current inference values obtained from the above estimation step includes four current inference values I1˜I4. However, the correspondence between the four current inference values I1˜I4 and the module series is not clear. That is, it is not sure each of the four current inference values I1˜I4 will correspond to which one of the four module series. Therefore, the current voltage history database is used to assist with the above determination. For example, there may be a shelter position neighboring to the solar panel, the position of the shelter shadow on the solar panel changes along with the movement of the sun. The first module series MS1, the second module series MS2 and the third module series MS3 may be shielded by the shelter shadow during the period of 9:00˜9:45, 10:00˜10:50 and 11:00˜12:00 respectively. Therefore, the three module series will have poor efficiency in power generation during different time periods. The current voltage history database shows that: the first module series has a first daily low power generation period T(X) of 9:00˜9:45, the second module series has a second daily low power generation period T(Y) of 10:00˜10:50, and the third module series has a third daily low power generation period T(Z) of 11:00˜12:00. Each daily low power generation period is different. For example, the first daily low power generation period T(X) is different from the second daily low power generation period T(Y).

Thus, the FHMM calculation module 24 performs at least one FHMM calculation during the first daily low power generation period of 9:00˜9:45 per day. Then, the set of second current inference values which is lowest during the first daily low power generation period T(X) is selected and used as the inference current value of the first module series and stored to the current voltage history database. Likewise, the FHMM calculation module 24 performs at least one FHMM calculation during the second daily low power generation period of 10:00˜10:50 per day. Then, the second current inference values which is lowest during the period T(Y) of 10:00˜11:00 is selected and used as the inference current value of the second module series, and stored to the current voltage history database. Thus, based on the features of the current voltage history database, the lowest current inference value during a specific period can be determined to be corresponding to which module series.

Over a period of time, the database building module 27 stores respective current inference value of the four module series under the circumstances of different temperatures and sunshine intensities. Moreover, the second current inference values newly obtained through calculation, the newly observed voltage values, and the environmental information, such as temperature/sunshine intensity, are stored to the current voltage history database per day as new reference data which will be used as historical data for future simulation and calculation. For example, in the present embodiment, at least one set of inference current values of each of the four module series and the corresponding environmental information, such as the temperature/sunshine intensity, when the total current is observed will be stored to the database every day.

In step (39), feedback is sent to the users. When the low power generation periods of each module series of the solar panel are different, the current of each module series can be recognized, and the FHMM calculation can be performed once in the corresponding daily low power generation period. Moreover, the environmental information module 22 detects the environmental information, including the sunshine intensity status and the temperature status, when the FHMM calculation is performed during the first daily low power generation period T(X). The current inference values obtained from the calculation algorithms and the observed voltage value are compared with the current voltage value under similar sunshine intensity status and temperature status among the current voltage history database when the FHMM calculation is performed. When relevant current values have huge difference, the user feedback module will issue an abnormality warning. For example, the FHMM calculation module 24 performs a FHMM calculation during the first daily low power generation period T(X) of 9:00˜9:45, and uses the lowest current of the set of second current inference values as the inference current value of the first module series. When the environmental information module 22 detects that the sunshine intensity status is at a moderate level and the temperature status is 25° C. when the FHMM calculation is performed during the period of 9:00˜9:45. The inference current value of the first module series is compared with the current voltage value under moderate level sunshine intensity status and temperature status near 25° C. among the current voltage history database. If the difference is over an abnormality threshold, then an abnormality warning is issued to the user.

While the invention has been described by way of example and in terms of the preferred embodiment (s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A power generation system abnormality diagnosis and analysis device for diagnosing and analyzing a solar panel power generation system in which a plurality of solar power generation module series are connected in parallel for outputting a total current, wherein the abnormality diagnosis and analysis device comprises:
a total current detection module for detecting a total current and outputting a time sequence data and an observed voltage value;
an environmental information module for providing an environmental information regarding the location of the solar panel power generation system;
a FHMM calculation module for performing a FHMM calculation on the time sequence data to obtain a plurality of sets of first current inference values and extracting a set of second current inference values from the plurality of sets of first current inference values according to the environmental information and a current voltage history database;
a database building module for recording the observed voltage value and the set of second current inference values to update the current voltage history database; and
a user feedback module for comparing the set of second current inference values and the observed voltage value with the current voltage history database to determine whether to issue an abnormality warning.

2. The power generation system abnormality diagnosis and analysis device according to claim 1, wherein the environmental information at least comprises a sunshine intensity status, and when the set of second current inference values is extracted from the plurality of sets of first current inference values, the current voltage value under similar sunshine intensity status among the current voltage history database is compared.

3. The power generation system abnormality diagnosis and analysis device according to claim 1, wherein the environmental information at least comprises a temperature status, and when the set of second current inference values is extracted from the plurality of sets of first current inference values, the current voltage value under similar temperature status among the current voltage history database is compared.

4. The power generation system abnormality diagnosis and analysis device according to claim 1, wherein when a set of second current inference values is extracted from the plurality of sets of first current inference values, at least two similarity extraction algorithms are used, the results of the at least two similarity extraction algorithms are accumulated and used as similarity measures, the current voltage value under similar environmental information among the current voltage history database is compared, and the current voltages with highest similarity are selected from the plurality of sets of first current inference values and used as the set of second current inference values.

5. The power generation system abnormality diagnosis and analysis device according to claim 4, wherein the at least two similarity extraction algorithms comprise at least two of the K-nearest neighbors algorithm, the inner product similarity matrix algorithm, the Gaussian kernel algorithm and the Euclidean distance algorithm.

6. The power generation system abnormality diagnosis and analysis device according to claim 1, wherein the current voltage history database shows that the X-th of the module series has a first daily low power generation period T(X) during which the FHMM calculation module performs at least one FHMM calculation and uses the lowest among the second current inference values during the first daily low power generation period T(X) as the inference current value of the X-th module series.

7. The power generation system abnormality diagnosis and analysis device according to claim 6, wherein the current voltage history database shows that the Y-th of the module series has a second daily low power generation period T(Y) during which the FHMM calculation module performs at least one FHMM calculation and uses the lowest among the second current inference values during the second daily low power generation period T(Y) as the inference current value of the Y-th module series, and the first daily low power generation period T(X) is different from the second daily low power generation period T(Y).

8. The power generation system abnormality diagnosis and analysis device according to claim 6, wherein the environmental information module detects a sunshine intensity status and a temperature status when the FHMM calculation is performed, the inference current value of the X-th module series and the observed voltage value are compared with the current voltage value under similar sunshine intensity status and temperature status among the current voltage history database to determine whether to issue an abnormality warning of the X-th module series.

9. A power generation system abnormality diagnosis and analysis method for diagnosing and analyzing a solar panel power generation system in which a plurality of solar power generation module series are connected in parallel for outputting a total current, wherein the abnormality diagnosis and analysis method comprises the steps of:
detecting the total current and outputting a time sequence data and an observed voltage value;
performing a FHMM calculation on the time sequence data to obtain a plurality of sets of first current inference values, and extracting a set of second current inference values from the plurality of sets of first current inference values according to an environmental information and a current voltage history database;
recording the observed voltage value and the second current inference values to update the current voltage history database; and
comparing the second current inference values and the observed voltage value with the current voltage history database to determine whether to issue an abnormality warning.

10. The power generation system abnormality diagnosis and analysis method according to claim 9, wherein the environmental information at least comprises a sunshine intensity status, and when the set of second current inference values is extracted from the plurality of sets of first current inference values, the current voltage value under similar sunshine intensity status among the current voltage history database is compared.

11. The power generation system abnormality diagnosis and analysis method according to claim 9, wherein the environmental information at least comprises a temperature status, and when the set of second current inference values is extracted from the plurality of sets of first current inference values, the current voltage value under similar temperature status among the current voltage history database is compared.

12. The power generation system abnormality diagnosis and analysis method according to claim 9, wherein when a set of second current inference values is extracted from the plurality of sets of first current inference values, at least two similarity extraction algorithms are used, the results of the at least two similarity extraction algorithms are accumulated and used as similarity measures, the current voltage value under similar environmental information among the current voltage history database is compared, and the current voltages with highest similarity are selected from the plurality of sets of first current inference values and used as the set of second current inference values.

13. The power generation system abnormality diagnosis and analysis method according to claim 12, wherein the at least two similarity extraction algorithms comprise at least two of the K-nearest neighbors algorithm, the inner product similarity matrix algorithm, the Gaussian kernel algorithm and the Euclidean distance algorithm.

14. The power generation system abnormality diagnosis and analysis method according to claim 9, wherein the current voltage history database shows that the X-th of the module series has a first daily low power generation period T(X) during which the FHMM calculation module performs at least one FHMM calculation and uses the lowest among the second current inference values during the first daily low power generation period T(X) as the inference current value of the X-th module series.

15. The power generation system abnormality diagnosis and analysis method according to claim 14, wherein the current voltage history database shows that the Y-th of the module series has a second daily low power generation period T(Y) during which the FHMM calculation module performs at least one FHMM calculation and uses the lowest among the second current inference values during the second daily low power generation period T(Y) as the inference current value of the Y-th module series, and the first daily low power generation period T(X) is different from the second daily low power generation period T(Y).

16. The power generation system abnormality diagnosis and analysis method according to claim 14, further comprising the step of: detecting a sunshine intensity status and a temperature status when the FHMM calculation is performed, wherein the inference current value of the X-th module series and the observed voltage value are compared with the current voltage value under similar sunshine intensity status and temperature status among the current voltage history database to determine whether to issue an abnormality warning of the X-th module series.
